(19) United States
(12) Patent Application Publication
(10) Pub. No.: US 2023/0272938 A1
(43) Pub. Date: Aug. 31, 2023

(54) COMPACT HEAT RECOVERY VENTILATION UNIT WITH BYPASS

(71) Applicant: ZEHNDER GROUP INTERNATIONAL AG, CH-5722 GRÄNICHEN (CH)

(72) Inventors: Stefan BONSINK, Kampen (NL); Eric ARENDS, Zwolle (NL); Sead AHMETHODZIC, Den Ham (NL)

(73) Assignee: ZEHNDER GROUP INTERNATIONAL AG, CH-5722 GRÄNICHEN (CH)

(21) Appl. No.: 18/016,102

(22) PCT Filed: Jul. 19, 2021
(86) PCT No.: PCT/EP2021/070130

§ 371 Date: Jan. 13, 2023

(30) Foreign Application Priority Data
Jul. 24, 2020 (CH) 00920/20

(51) Int. Cl. F24F 12/00; F24F 13/02

(52) U.S. Cl. CPC F24F 12/006; F24F 13/02; F24F 2012/007

(57) ABSTRACT

The invention relates to a ventilation unit (1) for providing supply air (SA), preferably outside air (OA) or fresh air, to an apartment or parts thereof and for removing return air (RA), preferably exhaust air (EA) or used air, from said apartment or parts thereof. The ventilation unit comprises a bypass valve (BV; BV∝) having a plurality of elongate members (EM; EM′) extending across a bypass duct and arranged in parallel next to each other, thus forming an arrangement of a plurality of elongate members next to each other as a one-elongate-member-thick layer. At least some elongate members (EM; EM′) of said plurality of elongate members (EM; EM′) are rotatably mounted around an axis of rotation (AR) parallel or identical to a longitudinal axis (LA) of said elongate members (EM; EM′). At least some elongate members (EM; EM′) are rotatable between a first rotational position or closed position (CP) and a second rotational position or open position (OP).

### BACKGROUND OF THE INVENTION

### Field of the Invention

The present invention relates to a ventilation unit for providing supply air, preferably outside air or fresh air, to an apartment or parts thereof and for removing return air, preferably exhaust air or used air, from said apartment or parts thereof.

### Discussion of Related Art

Heat recovery ventilation units have been used for many years in ventilation systems to recover heat from exhaust air exiting a house or an apartment to the surrounding atmosphere. A heat exchanger is used to transfer heat from the exhaust air exiting the house or the apartment to the outside air entering the house or the apartment. Such ventilation systems comprise an arrangement of ducts for transporting air between selected rooms of an apartment (or house) and the surrounding atmosphere. More precisely, such heat recovery ventilation systems comprise ducts collecting return air (used air) from the rooms, ducts for distributing supply air (fresh air) to the rooms on the one hand, and ducts for transporting exhaust air from the apartment to the atmosphere and ducts for transporting outside air from the atmosphere to the apartment. A heat recovery ventilation unit is located at a crossing point at which the ducts of these four air types meet. Consequently, such heat recovery ventilation units comprise a supply air outlet, a return air inlet, an exhaust air outlet, an outside air inlet and a heat exchanger inside the unit.

### SUMMARY OF THE INVENTION

It is an object of the invention to provide a heat recovery ventilation unit which, on the one hand, is compact and which, on the other hand, still allows enough air throughput without requiring too much energy for driving the ventilators in the unit and thus, without creating too much air flow noise.

This object is achieved by a ventilation unit for providing supply air, preferably outside air (fresh air), to an apartment or parts thereof and for removing return air, preferably exhaust air (used air), from said apartment or parts thereof, said ventilation unit comprising a supply air outlet for establishing supply air flow communication with said apartment; a return air inlet for establishing return air flow communication with said apartment; an exhaust air outlet for establishing exhaust air flow communication with the atmosphere; an outside air inlet for establishing outside air flow communication with the atmosphere; a heat exchanger having first air flow passages and second air flow passages for transferring heat energy from return air entering said first air flow passages and exhaust air leaving said first air flow passages on the one hand, to outside air entering said second air flow passages and supply air leaving said second air flow passages on the other hand; a first ventilator/fan at a first location within the ventilation unit, for transporting air through a first air flow path starting at said return air inlet, passing through said first air flow passages in the heat exchanger and ending at said exhaust air outlet; a second ventilator/fan at a second location within the ventilation unit, for transporting air through a second air flow path starting at said outside air inlet, passing through said second air flow passages in the heat exchanger and ending at said supply air outlet; a bypass duct forming a third air flow path around said heat exchanger; and a bypass valve arranged in said bypass duct for controlling air flow through said bypass duct, characterized in that said bypass valve comprises a plurality of elongate members extending across said bypass duct and arranged in parallel next to each other, thus forming an arrangement of a plurality of elongate members next to each other as a one-elongate-member-thick layer; at least some elongate members of said plurality of elongate members being rotatably mounted around an axis of rotation parallel to a longitudinal axis of said elongate member; wherein said at least some elongate members are rotatable between a first rotational position (or closed position) where said plurality of elongate members provides a maximum or infinite flow resistance to air flowing through said bypass duct, and a second rotational position (or open position) where said plurality of elongate members provides a minimum flow resistance to air flowing through said bypass duct.

As a result, due to the bypass valve being composed of a plurality of elongate members at least some of which are rotatable between a closed position with close-to-zero or zero air flow and an open position with normal bypass air flow, the bypass valve does not require a lot of space along the air flow direction when it transitions from its closed state to its open state. This is due to the fact that the radial dimension, i.e., the dimension orthogonal to the axis of rotation, of an individual elongate member is much smaller than the corresponding radial dimension of a valve having only one flap which is rotated when opening or closing the valve.

The first rotational position or closed position corresponds to a state where adjacent elongate members engage each other and provide a sealing function with low to zero air flow between adjacent elongate elements engaging each other.

The second rotational position or open position corresponds to a state where adjacent elongate members do not engage each other and do not provide any sealing function between adjacent elongate elements.

Preferably, a radial dimension of an elongate member from its axis of rotation to its surface varies as a function of angular direction (azimuth angle) within a plane orthogonal to said axis of rotation, thus defining angular directions with maximum radial dimension and angular directions with minimal radial dimensions. As a result, the first rotational position or closed position of an elongate member is provided by having its maximum radial dimension extend in a direction orthogonal the overall flow direction, thus causing maximum to infinite flow resistance, while the second rotational position or closed position of an elongate member is provided by having its minimal radial dimension extend in a direction orthogonal the overall flow direction, thus causing minimum flow resistance.

A radial dimension of an elongate member from its axis of rotation to its surface may vary as a function of axial location along said axis of rotation. For instance, angular directions with maximum radial dimension and angular directions with minimum radial dimension may alternate along the axial extension of an elongate member.

Preferably, at least a portion of an elongate member is made of an elastomer material. This helps improve the sealing function between adjacent elongate members engaging each other.

Preferably, an elongate member is made of an elastomer material at its radially outermost locations. It is at these radially outermost locations where an elongate member engages an adjacent elongate member. Such sealing engagement by is achieved by rotating the elongate member. By doing so, the radially outermost locations of the elongate member will first contact the adjacent elongate member and then elastically deform, thus creating a very good seal between adjacent elongate members.

The plurality of elongate members arranged in parallel next to each other may alternately comprise elongate members of a first type and elongate members of a second type. The elongate members of the first type may be elongate members rotatable around their longitudinal axis while the elongate members of the second type may be stationary elongate members which are fixedly mounted and not rotatable. The second type stationary elongate members may have a cross-sectional profile making them more rigid against bending in the air flow direction through the bypass valve than the first type stationary elongate members. As a result, the rigidity of the plurality of first type and second type elongate members of the bypass valve in their closed position is increased, thus minimizing any bending of the elongate members when exposed to a pressure difference.

Preferably, the first type of elongate members comprises formations of a first type at its radially outermost locations and that the second type of elongate members comprises formations of a second type at their radially outermost locations, said formations of a first type and said formations of a second type being complementary to each other. As a result, when sealing engagement is achieved by rotating at least one of two adjacent elongate members towards the first rotational position or closed position, these complementary formations combine, thus contributing to the sealing function.

Preferably, the first type of elongate members is made of an elastomer material at least at its radially outermost locations and the second type of elongate members is made of a non-elastomer material at least at their radially outermost locations. As a result, when sealing engagement is achieved by rotating at least one of two adjacent elongate members towards the first rotational position or closed position, elastomer material portions and non-elastomer material portions engage, thus contributing to the sealing function.

Preferably, the elongate members comprise a formation of a first type at a first radially outermost location and a formation of a second type at a second radially outermost location, said formation of a first type and said formation of a second type being diametrically opposite to each other.

Preferably, the elongate members comprise a formation of a first type at a first radially outermost location and a formation of a second type at a second radially outermost location, said formation of a first type and said formation of a second type being complementary to each other.

In a preferred embodiment, an elongate member comprises a first angular direction with a first maximum radial dimension and a second angular direction with a second maximum radial dimension, the first angular direction and the second angular direction differing by 180°, i.e., the first maximum radial dimension and the second maximum radial dimension are diametrically opposite to each other with respect to the longitudinal axis of rotation of the elongate member. Preferably, all elongate members comprise a first angular direction with a first maximum radial dimension and a second angular direction with a second maximum radial dimension. As a result, when the elongate member or all elongate members are in their first rotational position or closed position, the first and second angular directions with the maximum radial dimensions of the elongate members extend in a direction orthogonal to the air flow direction along the bypass duct, thus contributing to the sealing function.

The elongate members may be lamellae or slats or louvers.

The lamellae or slats or louvers, in their closed position, may have an overlap between 5% and 50% of their maximum radial dimension with adjacent lamellae or slots or louvers. Alternatively, the lamellae or slats or louvers, in their closed position, may have an overlap between 50% and 100% of their maximum radial dimension with adjacent lamellae or slots or louvers. The first version requires a somewhat smaller number of elongate members for constituting a bypass valve than the second version. In contrast, the second version may be stronger and provide a better sealing function that the first version.

The lamellae may have a lentil-shaped cross-section. Such lentil-shaped cross sections provide enough rigidity close to the axis of rotation, thus preventing unwanted bending. In addition, they lend themselves to good sealing between adjacent elongate members in their first rotational position or closed position, especially with some elastomer material portion at their radially outermost portions, and their air flow resistance and noise generating potential are quite low when they are in their second rotational position or open position.

Alternatively, the lamellae may have an S-shaped cross-section or a Z-shaped cross-section. The curved portions and the fold lines of the S-shaped cross-section and Z-shaped cross-section, respectively, have a rigidifying effect so that relatively thin sheet material, to be bent or folded into the S-shape or Z-shape, can be used. In addition, they too lend themselves to good sealing between adjacent elongate members in their first rotational position or closed position, especially with some elastomer material portion at their radially outermost portions.

Preferably, the elongate members arranged in parallel next to each other and forming an arrangement of a plurality of elongate members next to each other as a one-elongate-member-thick layer are rotatably supported in a frame. The frame provides the arrangement of elongate members of the bypass valve with sufficient strength.

Preferably, the elongate members have a first bearing formation at their first longitudinal end a second bearing formation at their second longitudinal end, the first bearing formation being rotatably supported in a third bearing formation in a first portion of the frame and complementary to the first bearing formation, and the second bearing formation being rotatably supported in a fourth bearing formation in a second portion of the frame and complementary to the second bearing formation, and the first portion and the second portion of the frame being opposite to each other.

Preferably, the frame is a rectangular frame with a first straight frame portion, a second straight frame portion, a third straight frame portion and a fourth straight frame portion.

Preferably, a drive motor (DM) drivingly connected to the elongate members is attached to the frame (2).

Preferably, the drive motor (DM) is drivingly connected to the elongate members via a mechanical power train.

The drive motor may be a motor with a rotatable output shaft that can be rotated to and stopped at any rotational (angular) position within a given angular range.

The drive motor may be a motor with a linearly reciprocable output shaft that can be translated to and stopped at any translational (linear) position within a given linear range.

Instead of a drive motor, a simple drive activator may be used.

The drive activator may be a switch-type activator with a rotatable output shaft that can be rotated between a first rotational end position and a second rotational end position.

The drive activator may be a switch-type activator with a linearly reciprocable output shaft that can be reciprocated between a first translational end position and a second translational end position.

The mechanical power train may be a rack and pinion drive, a worm gear drive or a belt drive, etc.

The first air flow path with outbound air flow starts at the return air inlet, passes through the first air flow passages in the heat exchanger and ends at the exhaust air outlet.

The second air flow path with inbound air flow starts at the outside air inlet, passes through the second air flow passages in the heat exchanger and ends at the supply air outlet. Preferably, the first ventilator/fan is arranged in the first air flow path downstream of the heat exchanger, i.e., between the heat exchanger and the exhaust air outlet.

Preferably, the second ventilator/fan is arranged in the second air flow path downstream of the heat exchanger, i.e., between the heat exchanger and the supply air outlet.

This arrangement of the ventilators with respect to the heat exchanger prevents dust particles from the outside air/atmosphere from entering the apartment or parts thereof. Also, it prevents the heat exchanger and the ventilators/fans from being exposed to dust particles, thus reducing their wear and increasing their lifetime.

Preferably, the air flow cross section of the return air inlet and the air flow cross section of the outside air inlet are greater than the air flow cross section of the supply air outlet and the air flow cross section of the exhaust air outlet.

Preferably, the bypass duct forming a third air flow path around the heat exchanger comprises two separate flow paths symmetrically bypassing the heat exchanger.

Preferably, the bypass valve can be moved from a first valve position corresponding to the first rotational position or closed position of the plurality of elongate members, allowing return air to pass through the heat exchanger along the outbound first air flow path and allowing outside air to pass through the heat exchanger along the inbound second air flow path, to a second valve position corresponding to the second rotational position or open position of the plurality of elongate members, allowing return air and outside air to bypass the heat exchanger.

Preferably, the bypass valve is associated to a valve drive unit acting on the bypass valve, and wherein the valve drive unit is located inside the ventilation unit at a central location halfway in between the first air flow path and the second air flow path.

Preferably, the air flow cross section of the return air inlet and the air flow cross section of the outside air inlet are greater than the air flow cross section of the supply air outlet and the air flow cross section of the exhaust air outlet. Given the fact that the return air duct portions and the outside air duct portions are driven in suction mode with respect to atmospheric pressure, the greater cross sections in these duct portions minimize overall pressure drop in the first air flow path driven by the first ventilator, on the one hand, and overall pressure drop in the second air flow path driven by the second ventilator, on the other hand. This improves the performance of the unit with respect to air throughput (increased) and noise generation (reduced).

Preferably, the bypass duct forming a third air flow path around the heat exchanger comprises two separate flow paths symmetrically bypassing the heat exchanger. Again, this improves the performance of the unit with respect to air throughput and noise generation.

Preferably, the bypass valve is associated to a valve drive unit acting on the bypass valve, and wherein the valve drive unit is located inside the ventilation unit at a central location halfway in between the first air flow path and the second air flow path. This contributes to the compactness of the unit.

Preferably, at least a major portion, preferably at least 80%, of the entire length of each of the internal air flow ducts of the ventilation unit are of substantially rectangular flow cross section. Due to the rectangular cross sections of the internal air flow ducts, the ducts can be arranged in a very compact manner within the housing of the heat recovery ventilation unit of the invention, thus allowing relatively large duct cross sections within a minimum of equipment space. As a result, a very compact heat recovery ventilation unit is achieved without reducing the performance with respect to air throughput and noise generation.

### BRIEF DESCRIPTION OF SEVERAL VIEWS OF THE DRAWINGS

FIG. 1 is a top view or bottom view of an embodiment of the heat recovery ventilation unit according to the invention with a housing wall removed.

FIG. 2 is a perspective view of the embodiment of the heat recovery ventilation unit according to the invention with a housing wall removed.

FIG. 3 is a perspective view of a first variant of a component included in the embodiment of the heat recovery ventilation unit according to the invention.

FIG. 4 is a top view of the first variant of the component shown in FIG. 3.

FIG. 5 is a sectional view of section C-C in FIG. 4.

FIG. 6 is an enlarged view of detail D shown in FIG. 5.

FIG. 7 is a perspective view of a second variant of a component included in the embodiment of the heat recovery ventilation unit according to the invention.

FIG. 8 is a top view of the second variant of the component shown in FIG. 7.

FIG. 9 is a sectional view of section C-C in FIG. 8.

FIG. 10 is a perspective view of a portion of the second variant of the component shown in FIG. 7.

FIG. 11 is an enlarged view of detail D shown in FIG. 10.

FIG. 12 is a perspective view of a third variant of a component included in the embodiment of the heat recovery ventilation unit according to the invention.

FIG. 13 is a top view of a fourth variant of a component included in the embodiment of the heat recovery ventilation unit according to the invention.

FIG. 14 is a cross-sectional view of a fifth variant of a component included in the embodiment of the heat recovery ventilation unit according to the invention.

FIG. 15 is a cross-sectional view of a sixth variant of a component included in the embodiment of the heat recovery ventilation unit according to the invention.

FIG. 16 is a cross-sectional view of a seventh variant of a component included in the embodiment of the heat recovery ventilation unit according to the invention.

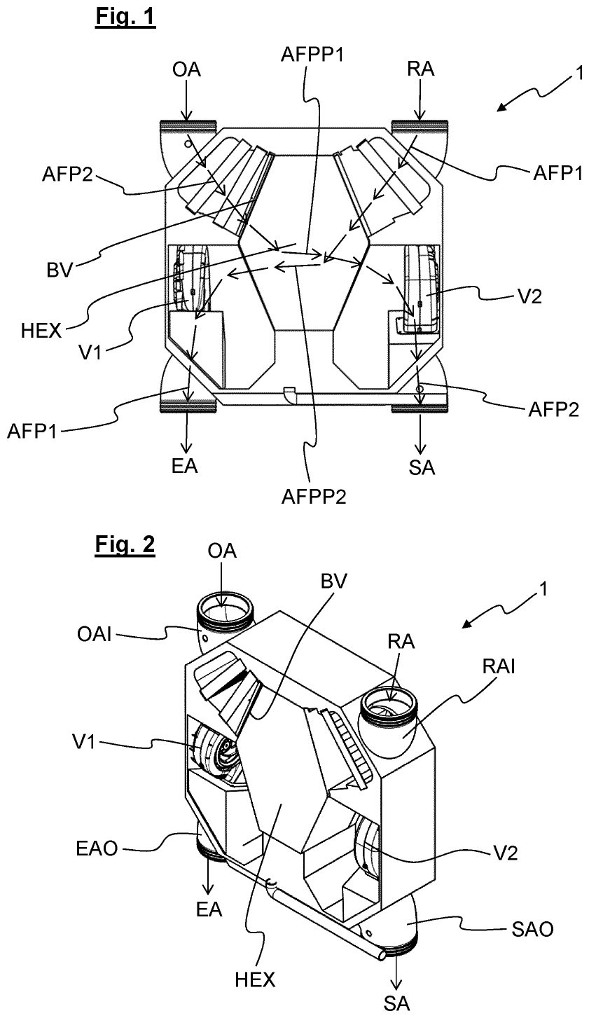

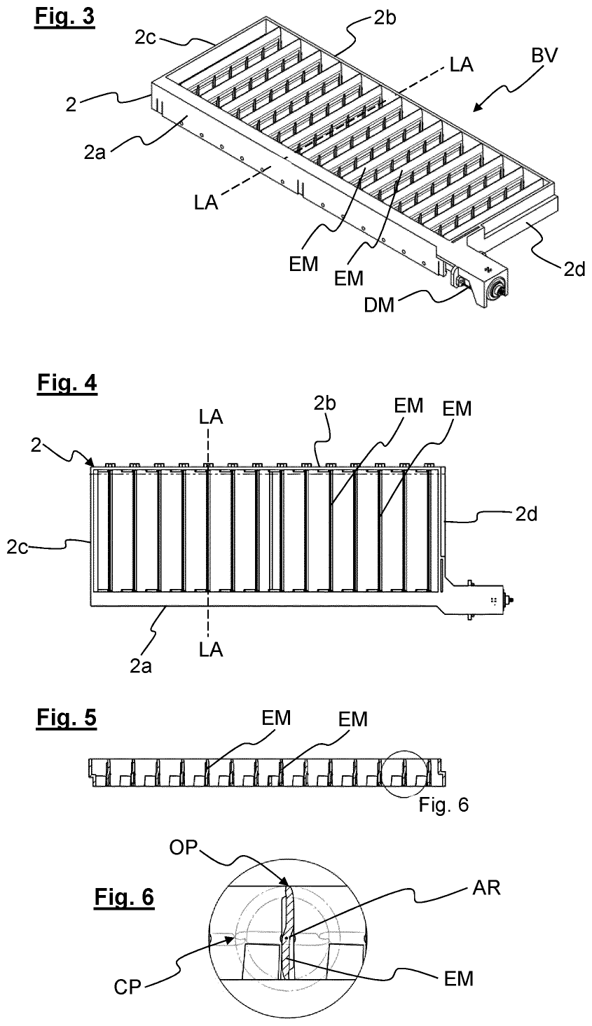

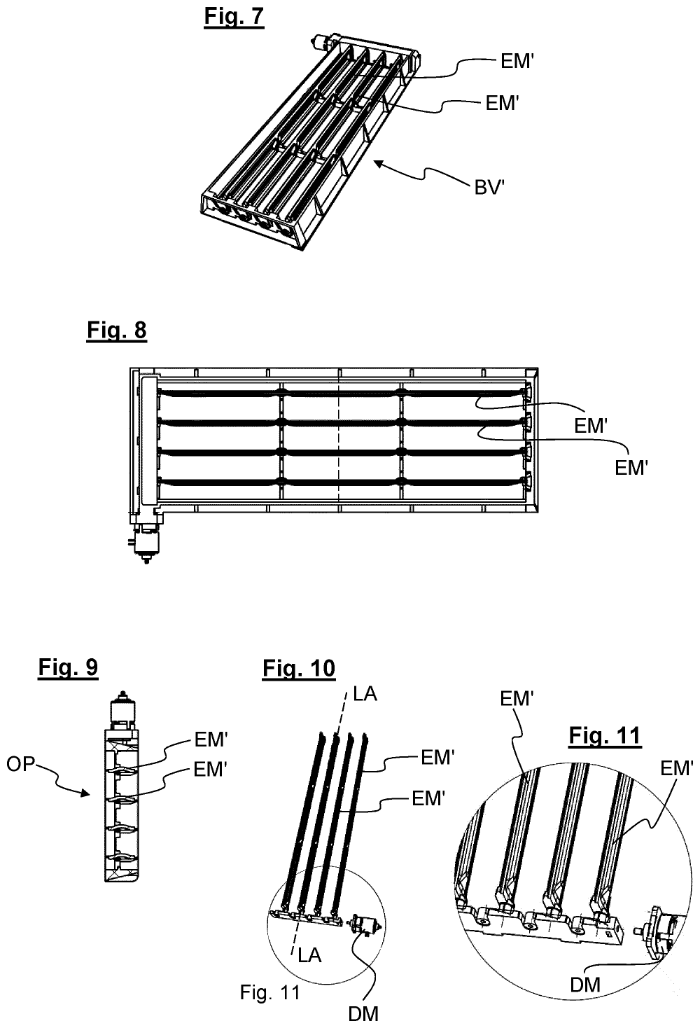

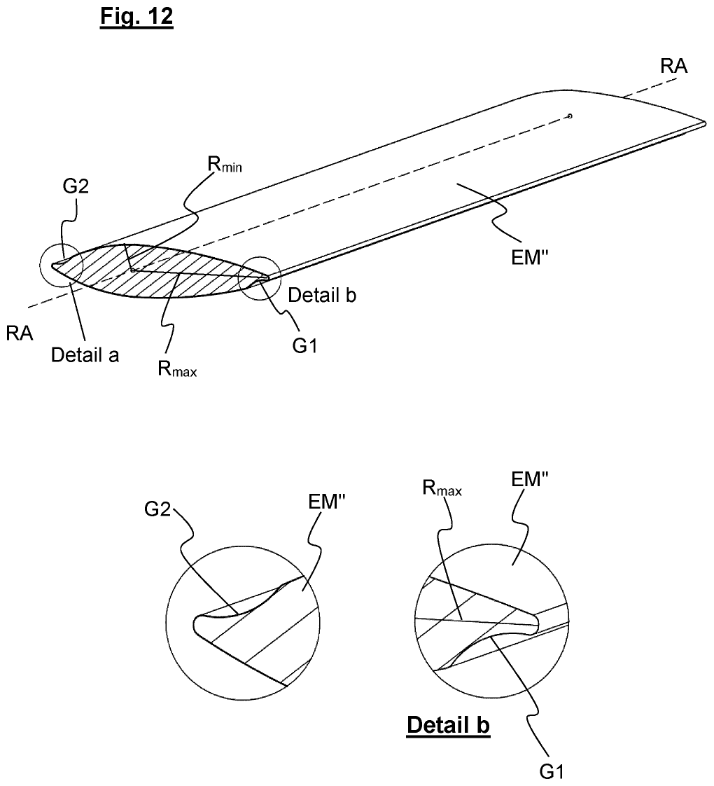

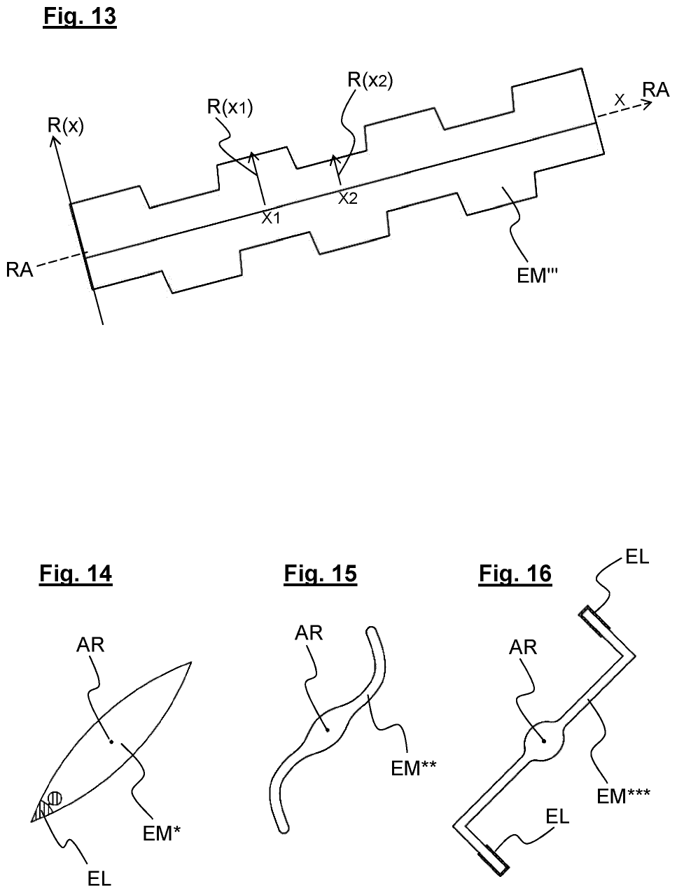

### DETAILED DESCRIPTION OF THE ELEMENTS

1 ventilation unit
RA return air
EA exhaust air
OA outside air
SA supply air
RAI return air inlet
EAO exhaust air outlet
OAI outside air inlet
SAO supply air outlet
AFP1 first air flow path (within unit, RAI→EAO)
AFP2 second air flow path (within unit, OAI→SAO)
AFPP1 first air flow passages (within heat exchanger), part of AFP1
AFPP2 second air flow passages (within heat exchanger), part of AFP2
V1 first ventilator/fan
V2 second ventilator/fan
BV bypass valve (first variant)
BV′ bypass valve (second variant)
EM elongate member (first variant)
EM′ elongate member (second variant)
EM″ elongate member (third variant)
EM′″ elongate member (fourth variant)
EM* elongate member (fifth variant)
EM** elongate member (sixth variant)
EM***elongate member (seventh variant)
LA longitudinal axis
AR axis of rotation
OP open position
CP closed position
DM drive motor
Rₘₐₓ maximum radial dimension
Rₘᵢₙ minimum radial dimension
G1 formation of a first type
G2 formation of a first type
2 frame of bypass valve
2a frame portion
2b frame portion
2c frame portion
2d frame portion

1. A ventilation unit (1) for providing supply air (SA), preferably outside air (OA) or fresh air, to an apartment or parts thereof and for removing return air (RA), preferably exhaust air (EA) or used air, from said apartment or parts thereof, said ventilation unit (1) comprising:
a supply air outlet (SAO) for establishing supply air flow communication with said apartment;
a return air inlet (RAI) for establishing return air flow communication with said apartment;
an exhaust air outlet (EAO) for establishing exhaust air flow communication with the atmosphere;
an outside air inlet (OAI) for establishing outside air flow communication with the atmosphere;
a heat exchanger (HEX) having first air flow passages (AFPP1) and second air flow passages (AFPP2) for transferring heat energy from return air (RA) entering said first air flow passages (AFP1) and exhaust air (EA) leaving said first air flow passages (AFP1), to outside air (OA) entering said second air flow passages (AFP2) and supply air (SA) leaving said second air flow passages (AFP2);
a first ventilator/fan (V1) at a first location within the ventilation unit (1), for transporting air through a first air flow path (AFP1) starting at said return air inlet (RAI), passing through said first air flow passages (AFPP1) in the heat exchanger (HEX) and ending at said exhaust air outlet (EAO);
a second ventilator/fan (V2) at a second location within the ventilation unit (1), for transporting air through a second air flow path (AFP2) starting at said outside air inlet (OAI), passing through said second air flow passages (AFPP2) in the heat exchanger (HEX) and ending at said supply air outlet (SAO);
a bypass duct forming a third air flow path around said heat exchanger (HEX); and
a bypass valve (BV; BV′) arranged in said bypass duct for controlling air flow through said bypass duct, wherein said bypass valve (BV; BV′) comprises a plurality of elongate members (EM; EM′) extending across said bypass duct and arranged in parallel next to each other, thus forming an arrangement of a plurality of elongate members next to each other as a one-elongate-member-thick layer;
at least some elongate members (EM; EM′) of said plurality of elongate members (EM; EM′) being rotatably mounted around an axis of rotation (AR) parallel or identical to a longitudinal axis (LA) of said elongate members (EM; EM′);
wherein said at least some elongate members (EM; EM′) are rotatable between
a first rotational position or closed position (CP) where said plurality of elongate members (EM; EM′) provides a maximum or infinite flow resistance to air flowing through said bypass duct, and
a second rotational position or open position (OP) where said plurality of elongate members (EM; EM′) provides a minimum flow resistance to air flowing through said bypass duct.

2. A ventilation unit according to claim 1, wherein a radial dimension R of an elongate member (EM″) from its axis of rotation (AR) to its surface varies as a function of angular direction (azimuth angle) within a plane orthogonal to said axis of rotation (AR), thus defining angular directions with maximum radial dimension (Rmax) and angular directions with minimal radial dimensions (Rmin).

3. A ventilation unit according to claim 1, wherein a radial dimension R(x) of an elongate member (EM′″) from its axis of rotation (AR) to its surface varies as a function of axial location x along said axis of rotation.

4. A ventilation unit according to claim 1, wherein at least a portion (EL) of an elongate member (EM*; EM***) is made of an elastomer material.

5. A ventilation unit according to claim 4, wherein an elongate member (EM*; EM***) is made of an elastomer material (EL) at its radially outermost locations.

6. A ventilation unit according to claim 1, wherein said plurality of elongate members arranged in parallel next to each other alternately comprises elongate members of a first type and elongate members of a second type.

7. A ventilation unit according to claim 6, wherein said first type of elongate members comprises formations of a first type (G1) at its radially outermost locations and that said second type of elongate members comprises formations of a second type (G2) at their radially outermost locations, said formations of a first type and said formations of a second type being complementary to each other.

8. A ventilation unit according to claim 6, wherein said first type of elongate members is made of an elastomer material at least at its radially outermost locations and that said second type of elongate members is made of a non-elastomer material at least at their radially outermost locations.

9. A ventilation unit according to claim 1, wherein said elongate members comprise a formation of a first type (G1) at a first radially outermost location and a formation of a second type (G2) at a second radially outermost locations, said formation of a first type (G1) and said formation of a second type (G2) being diametrically opposite to each other.

10. A ventilation unit according to claim 1, wherein said elongate members comprise a formation of a first type (G1) at a first radially outermost location and a formation of a second type (G2) at a second radially outermost locations, said formation of a first type (G1) and said formation of a second type (G2) being complementary to each other.

11. A ventilation unit according to claim 2, wherein said elongate member comprises a first angular direction with a first maximum radial dimension and a second angular direction with a second maximum radial dimension, said first angular direction and said second angular direction differing by 180° (first maximum radial dimension and second maximum radial dimension being diametrically opposite to each other).

12. A ventilation unit according to claim 11, wherein said elongate members are lamellae or slats or louvers.

13. A ventilation unit according to claim 12, wherein said lamellae or slats or louvers, in their closed position, have an overlap between 5% and 50% of their maximum radial dimension with adjacent lamellae or slots or louvers.

14. A ventilation unit according to claim 13, wherein said lamellae or slats or louvers, in their closed position, have an overlap between 50% and 100% of their maximum radial dimension with adjacent lamellae or slots or louvers.

15. A ventilation unit according to claim 14, wherein lamellae (EM*) have a lentil-shaped cross-section.

16. A ventilation unit according to claim 15, wherein said lamellae (EM**; EM***) have an S-shaped or Z-shaped cross-section.

17. A ventilation unit according to claim 1, wherein said elongate members (EM; EM′) arranged in parallel next to each other and forming an arrangement of a plurality of elongate members next to each other as a one-elongate-member-thick layer are rotatably supported in a frame (2).

18. A ventilation unit according to claim 17, wherein each of said elongate members (EM; EM′) have a first bearing formation at their first longitudinal end a second bearing formation at their second longitudinal end, said first bearing formation being rotatably supported in a third bearing formation in a first portion (2a) of said frame (2) and complementary to said first bearing formation, and said second bearing formation being rotatably supported in a fourth bearing formation in a second portion (2b) of said frame (2) and complementary to said second bearing formation, said first portion (2a) and said second portion (2b) of said frame being opposite to each other.

19. A ventilation unit according to claim 17, wherein said frame (2) is a rectangular frame with a first straight frame portion (2a), a second straight frame portion (2b), a third straight frame portion (2c) and a fourth straight frame portion (2d).

20. A ventilation unit according to claim 17, wherein a drive motor (DM) drivingly connected to said elongate members (EM; EM′) is attached to said frame (2).

21. A ventilation unit according to claim 20, wherein said drive motor (DM) is drivingly connected to said elongate members (EM; EM′) via a mechanical power train.

22. A ventilation unit according to claim 1, wherein said first ventilator/fan (V1) is arranged in said first air flow path (AFP1) downstream of the heat exchanger (HEX) between said heat exchanger (HEX) and said exhaust air outlet (EAO).

23. A ventilation unit according to claim 1, wherein said second ventilator/fan (V2) is arranged in said second air flow path (AFP2) downstream of the heat exchanger between said heat exchanger (HEX) and said supply air outlet (SAO).

24. A ventilation unit according to claim 1, wherein the air flow cross section of said return air inlet and the air flow cross section of said outside air inlet are greater than the air flow cross section of said supply air outlet and the air flow cross section of said exhaust air outlet.

25. A ventilation unit according to claim 1, wherein said bypass duct forming a third air flow path around said heat exchanger comprises two separate flow paths symmetrically bypassing said heat exchanger.

26. A ventilation unit according to claim 1, wherein said bypass valve can be moved from a first valve position allowing return air to pass through the heat exchanger along said outbound first air flow path and allowing outside air to pass through the heat exchanger along said inbound second air flow path, to a second valve position allowing return air outside air to bypass the heat exchanger.

27. A ventilation unit according to claim 1, wherein said bypass valve is associated to a valve drive unit acting on said bypass valve, and wherein said valve drive unit is located inside the ventilation unit at a central location halfway in between said first air flow path and said second air flow path.

28. A ventilation unit according to claim 1, wherein at least 80% of the entire length of each of the internal air flow ducts of the ventilation unit are of substantially rectangular flow cross section.
